(19) United States
(12) Patent Application Publication
(10) Pub. No.: US 2013/0346182 A1
(43) Pub. Date: Dec. 26, 2013

(54) MULTIMEDIA FEATURES FOR CLICK PREDICTION OF NEW ADVERTISEMENTS

(71) Applicants: Haibin Cheng, San Jose, CA (US); Roelof van Zwol, Sunnyvale, CA (US); Javad Azimi, Corvallis, OR (US); Eren Manavoglu, Menlo Park, CA (US); Ruofei Zhang, Mountain View, CA (US); Yang Zhou, Santa Clara, CA (US); Vidhya Navalpakkam, Sunnyvale, CA (US)

(72) Inventors: Haibin Cheng, San Jose, CA (US); Roelof van Zwol, Sunnyvale, CA (US); Javad Azimi, Corvallis, OR (US); Eren Manavoglu, Menlo Park, CA (US); Ruofei Zhang, Mountain View, CA (US); Yang Zhou, Santa Clara, CA (US); Vidhya Navalpakkam, Sunnyvale, CA (US)

(73) Assignee: YAHOO! INC., Sunnyvale, CA (US)

(21) Appl. No.: 13/528,484

(22) Filed: Jun. 20, 2012

(51) Int. Cl. G06Q 30/02

(52) U.S. Cl. 705/14.41

(57) ABSTRACT

Multimedia features extracted from display advertisements may be integrated into a click prediction model for improving click prediction accuracy. Multimedia features may help capture the attractiveness of ads with similar contents or aesthetics. Numerous multimedia features (in addition to user, advertiser and publisher features) may be utilized for the purposes of improving click prediction in ads with limited or no history.

### BACKGROUND

Online advertising may be an important source of revenue for enterprises engaged in electronic commerce. Processes associated with technologies such as Hypertext Markup Language (“HTML”) and Hypertext Transfer Protocol (“HTTP”) enable a web page to be configured to display advertisements. Advertisements may commonly be found on many web sites. Web site publishers, such as news and sports web sites, may provide space for advertisements. The publishers of these web sites may sell advertising space to advertisers to defray the costs associated with operating the web sites as well as to obtain additional revenue.

Non-guaranteed display advertising (“NGD”) may refer to advertising in which advertisers pay based on ad performance and results. Advertisers in NGD may sell a large portion of their ad campaigns using performance dependent pricing models such as cost-per-click (“CPC”) and cost-per-action (“CPA”). Pricing for NGD advertising may be difficult because it may be necessary to approximate or predict the probability that users click on ads. That value may be required to compute the expected revenue.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a diagram of an exemplary network system;

FIG. 2 is a diagram of an exemplary click predictor;

FIG. 3 is a diagram of exemplary ad types;

FIG. 4 is a diagram of exemplary multimedia features;

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

By way of introduction, multimedia features extracted from display advertisements (“ads”) may be integrated into a click prediction model for improving click prediction accuracy. Multimedia features may help capture the attractiveness of ads with similar contents or aesthetics. Numerous multimedia features (in addition to commonly used user, advertiser and publisher features) may be utilized for the purposes of improving click prediction in ads with limited or no history.

Advertisers may be provided with a wide range of pricing models. Similar to guaranteed delivery (“GD”) advertisements, advertisers with NGD ads can choose to pay per impression (“CPM”). However, advertisers may also prefer to pay if the ad attracted the user's attention. Accordingly, an additional type of NGD advertising payment scheme provides performance based pricing models such as pay-per click (“CPC”) and pay-per-conversion (“CPA”), which can be further categorized as post-view or post-click, depending on there being a click before the conversion event. In a marketplace where ads with different payment models are competing for the same opportunity, the auction mechanism may need to convert the bids to a common currency. This may be accomplished by computing expected revenue (“eCPM”). For a CPM ad the expected revenue is going to be the same as the bid. For a CPC ad, however, the expected revenue depends on the probability that the user will click on that ad. Similarly, the expected revenue of a post-view CPA ad depends on the probability of conversion after the user views the ad; and for post-click CPA the expected revenue calculation may take into account both the click and the conversion probability. As a result, accurate prediction of click probability may be important in NGD advertising, but is also relevant for GD advertising as well.

In NGD advertising a spot auction may be run for every ad slot on the publisher's page, in which advertisers with matching target profiles participate. The ads may be ranked based on their expected revenue and the winning ad is displayed. Estimating the expected revenue for pay-per click and post-click conversion payment models requires knowing the probability that the user will click on the candidate ad if shown in that ad slot on the publisher's page. A NGD system may rely on machine learning models to estimate the click and conversion probability of eligible CPC/CPA ads. These models may be trained using data collected from live systems. The identity of the users, publishers and ads may be used as features in such models, together with other high level category information. For ads that have been in the system for a long period of time, the estimation of click probability using identifier based features may be generally reliable, however it becomes more difficult for new ads. Identifier based features for advertisers do not provide any information about the aesthetics or the content of the ads, which may be a key factor that the user responds to.

Accordingly, multimedia features may be extracted from ads and used to improve click prediction. The multimedia features may be used to represent the content (and aesthetics) of ads. The features may be extracted from static images as well as animated flash ads or other multimedia ads. A clustering model based approach may be used to capture the shared visual content and a feature selection algorithm may be developed to remove features with low click relevancy and high redundancy.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

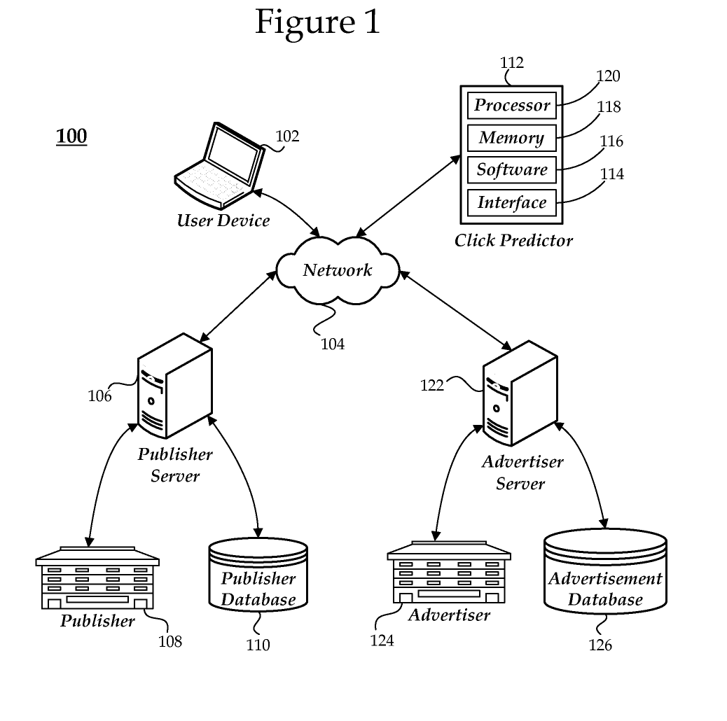

FIG. 1 depicts a block diagram illustrating one embodiment of an exemplary advertising system 100. The advertising system 100 may provide a platform for implementing and displaying NGD advertisements. In the advertising system 100, a user device 102 is coupled with a publisher server 106 through a network 104. The publisher server 106 may be operated by and/or coupled with a publisher 108, as well as being coupled with a publisher database 110. An advertiser server 122 coupled with an advertiser 124 may also be coupled with an advertisement database 126. A click predictor 112 may be coupled with the publisher server 106 and the advertiser server 122. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided. Accordingly, the click predictor 112 may be coupled through a network (e.g. the network 104) with the publisher server 106 and the advertiser server 122.

The user device 102 may be a computing device which allows a user to connect to a network 104, such as the Internet. As described below, the user device 102 may be a third party user who views an advertisement. In alternative embodiments, the user device 120 as described herein may be how the publisher and/or advertiser 124 accesses the NGD advertisement system for buying, selling, and click-predicting of advertisements. The user device 102 may also be referred to as a client device.

The user device 102 may include a computing device capable of sending or receiving signals, such as via a wired or a wireless network (e.g. the network 104, which may be the Internet). The user device 102 may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. The user device 102 may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

The user device 102 may include or may execute a variety of operating systems, including a personal computer operating system, such as a Windows, iOS or Linux, or a mobile operating system, such as iOS, Android, or Windows Mobile, or the like. The user device 102 may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. The user device 102 may also include or execute an application to communicate content, such as, for example, textual content, multimedia content, or the like. The user device 102 may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

In one embodiment, the user device 102 is configured to request and receive information from a network (e.g. the network 104, which may be the Internet). The information may include web pages with advertisements. The user device 102 may be configured to access other data/information in addition to web pages over the network 104 using a web browser, such as INTERNET EXPLORER® (sold by Microsoft Corp., Redmond, Wash.) or FIREFOX® (provided by Mozilla). In an alternative embodiment, software programs other than web browsers may also display advertisements received over the network 104 or from a different source. As described below, the ads are displayed in a web page and the click prediction is used for the sale of publisher ad space for those ads.

In one embodiment, the publisher server 106 provides an interface to a network 104 and/or provides its web pages over the network, such as to the user device 102. The publisher server 106 may be a web server that provides the user device 102 with pages (including advertisements) that are requested over the network, such as by a user of the user device 102. In particular, the publisher 108 may provide a web page, or a series of web pages that are provided by the publisher server 106 when requested from the user device 102. For example, the publisher may be a news organization, such as CNN® that provides all the pages and sites associated with www.cnn.com. Accordingly, when the user device 102 requests a page from www.cnn.com, that page is provide over the network 104 by the publisher server 106. That page may include advertising space or advertisement slots that are filled with advertisements viewed with the page. The publisher server 106 may be operated by a publisher 108 that maintains and oversees the operation of the publisher server 106.

The publisher 108 may be any operator of a page displaying advertisements that receives a payment from the advertisers of those advertisements. As described, the click prediction may be used below by the publisher 108 for pricing the sale of the ad slots in the publisher's pages. The publisher 108 may oversee the publisher server 106 by receiving advertisements from an advertiser server 122 that are displayed in pages (e.g. a destination web page) provided by the publisher server 106. In one embodiment, a click predictor 112 may be used by the publisher 108 to accurately price the sale of ad slots/locations on one or more of its pages.

The publisher database 110 may be coupled with the publisher server 106 and may store the publisher's pages or data that is provided by the publisher server 106. The pages that are stored may have ad slots for displaying advertisements. The publisher database 110 may include records or logs of at least a subset of the requests for data/pages and ads submitted to the publisher server 106. In one example, the publisher database 110 may include a history of Internet browsing data related to the pages provided by the publisher server 106. The publisher database 110 may store advertisements from a number of advertisers, such as the advertiser 124. In addition, the publisher database 110 may store records on the advertisements that are shown and the resulting impressions, clicks, and/or actions taken for those advertisements. The data related to advertisement impressions, clicks and resulting actions may be stored in either the publisher database 110 and/or an advertiser database 126. This data can be used for the pricing of future NGD ads and ad campaigns

The advertiser server 122 may provide advertisements for display in web pages, such as the publisher's pages. In one embodiment, the advertiser server 122 is coupled with the publisher server 106 for providing ads on the publisher's web pages. The advertiser 124 may be any operator of the advertiser server 122 for providing advertisements. The advertisements may relate to products and/or services provided by the advertiser 124. The advertiser 124 may pay the publisher 108 for advertising space on the publisher's page or pages. The payment may be based on the click prediction described below for NGD ads. The advertiser 124 may oversee the advertiser server 122 by providing advertisements to the publisher server 106. The advertiser 124 may pay the publisher 108 for each impression, click, and/or conversion from the ads displayed on the publisher's pages.

The publisher server 106 and/or the advertiser server 122 may be one or more computing devices which may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In addition, the publisher server 106 and/or the advertiser server 122 may be or may be part of a content server. A content server may include a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc. A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type or programmable consumer electronics, etc.

The click predictor 112 may predict whether a user will click on or interact with an advertisement. In one embodiment, the click prediction may be designed for new advertisements for which there is no historical click/interaction information. As described, click prediction may include a prediction on whether a user will click on an ad and/or whether a user will interact with an ad and/or whether a conversion may result from the interaction with the ad. The click prediction may incorporate historical click data for related or similar advertisements. As described below, certain multimedia features may be extracted from an ad and compared with multimedia features of other ads (for which historical click data is available) to model or predict a click amount for that ad. The click prediction may be used for pricing and selling ad space for particular ads. For example, an ad with certain multimedia features may be compared with previous ads using similar multimedia features and based on the click/interaction history of the previous ads, the click prediction may be estimated for this ad based on those certain multimedia features.

The click predictor 112 may predict clicks/interactions for ads (e.g. new ads with no historical data) as discussed below. The click predictor 112 may be coupled with the publisher server 106 and the advertiser server 122 for providing the predictions which may be used in the sale of the ads for display. In one embodiment, the ad may be provided by the advertiser server 122 for click prediction analysis which is used to establish the pricing for the display of that advertisement by the publisher server 106. In one embodiment, the click predictor 112 may be controlled by the publisher 108 and may be a part of the publisher server 106. Alternatively, the click predictor 112 may be controlled by the advertiser 124 and may be a part of the advertiser server 122, or may be part of a separate entity. The click predictor 112 may receive advertisements from a number of different advertisers, such as the advertiser 124. The click predictor 112 may be utilized by the different advertisers for testing different publishers' pages for displaying their ads. Likewise, the click predictor 112 may be utilized by the different publishers for identifying advertisers' ads that have the highest predicted click rate or interaction rate.

The click predictor 112 may be a computing device for predicting clicks/interactions with ads. The click predictor 112 may include a processor 120, memory 118, software 116 and an interface 114. The click predictor 112 may be a separate component from the publisher server 106 and/or the advertiser server 122, or may be combined as a single component or device.

The interface 114 may communicate with any of the user device 102, the publisher server 106, and/or the advertiser server 122. The interface 114 may include a user interface configured to allow a user and/or administrator to interact with any of the components of the click predictor 112. For example, the administrator and/or user may be able to configure and/or update the model used by the click predictor 112, including modifying the features (e.g. multimedia features) that used for predicting the clicks.

The processor 120 in the click predictor 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with a memory 118, or the memory 118 may be a separate component. The interface 114 and/or the software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded ad or user data. Examples include a hard drive, compact disc (“CD”), digital video disc (“DVD”), memory card, memory stick, floppy disc, universal serial bus (“USB”) memory device, or any other device operative to store ad or user data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116. The software 116 may include instructions for modeling and predicting a click rate for ads.

The interface 114 may be a user input device or a display. The interface 114 may include a keyboard, keypad or a cursor control device, such as a mouse, or a joystick, touch screen display, remote control or any other device operative to interact with the click predictor 112. The interface 114 may include a display coupled with the processor 120 and configured to display an output from the processor 120. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing input parameters. In particular, the interface 114 may allow a user to interact with the click predictor 112 to view or modify the multimedia features that are modeled for click prediction as well as providing results from the click prediction.

The present disclosure contemplates a computer-readable medium that includes instructions or receives and executes instructions responsive to a propagated signal, so that a device connected to a network can communicate voice, video, audio, images or any other data over a network. The interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly. Any of the components in the advertising system 100 may be coupled with one another through a network, including but not limited to the network 104. For example, the click predictor 112 may be coupled with the publisher server 106 and/or the advertiser server 122 through a network. As another example, the advertiser database 126 may be coupled with the publisher server 106 and/or the click predictor 112 through a network. Accordingly, any of the components in the advertising system 100 may include communication ports configured to connect with a network, such as the network 104.

The network (e.g. the network 104) may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example. For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

The network connecting the devices described above (e.g. the network 104) may be a “content delivery network” or a “content distribution network” (CDN). For example, the publisher server 106 and/or the advertiser server 122 may be part of a CDN. A CDN generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Likewise, the network connecting the devices described above (e.g. the network 104) may be a peer-to-peer (or P2P) network that may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.” For example, the ad server 122 or the publisher server 106 may provide advertisements and/or content to the user device 102 over a P2P network, such as the network 104.

The publisher server 106, the publisher database 110, the click predictor 112, the advertiser server 122, the advertiser database 126, and/or the user device 102 may represent computing devices of various kinds. Such computing devices may generally include any device that is configured to perform computation and that is capable of sending and receiving data communications by way of one or more wired and/or wireless communication interfaces, such as interface 114. For example, the user device 102 may be configured to execute a browser application that employs HTTP to request information, such as a web page, from the publisher server 106. The present disclosure contemplates the use of a computer-readable medium that includes instructions or receives and executes instructions responsive to a propagated signal, so that any device connected to a network can communicate voice, video, audio, images or any other data over a network.

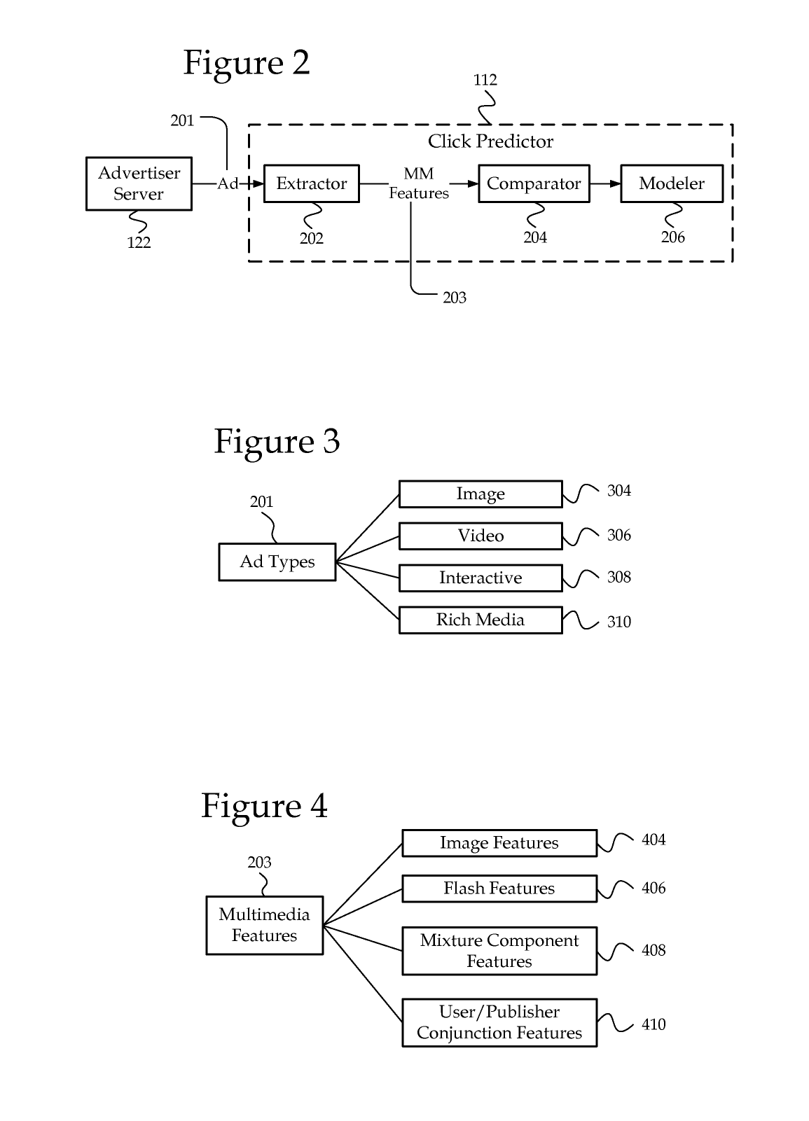

FIG. 2 is a diagram of an exemplary click predictor 112. The click predictor 112 may receive an ad 201 from the advertiser server 122 and predict or model the response to that ad. The response may include clicks, interactions, or conversions with the ad. The pricing for the ad may be based on the predicted or modeled response. The click predictor 112 may include an extractor 202 for extracting multimedia features 203 from the ad. The multimedia features 203 are further described below with respect to FIG. 4. The multimedia features 203 of the ad 201 are used by the click predictor 112 for predicting a response (e.g. clicks or conversions) to the ad. In particular, the multimedia features 203 may be used for predicting a response to a new ad that has no historical data about previous responses to the ad. In particular, the multimedia features 203 may be extracted from the extractor 202 and compared by the comparator 204. The comparison may include historical click data (not shown) from ads with similar multimedia features. The historical click data that is compared by the comparator 204 may be from the advertisement database 126 and/or the publisher database 110. The click predictor 112 may further include a modeler 206 that develops and implements a click prediction model for predicting clicks of ads, such as new ads. In one embodiment, the results from the comparator 204 are input into the modeler 206. In another embodiment, the comparator 204 may be excluded, and the click predictor 112 may just include a modeler 206 that receives multimedia features 203 as an input and outputs the predicted response (e.g. clicks or conversions).

The modeler 206 may formulate the click prediction problem in NGD as a classification problem, where each data point represents a publisher-ad pair presented to the user. Assuming there is a set of n training samples, D={(f(pⱼ, aⱼ, uⱼ), cⱼ){ⁿⱼ=1, where f(pⱼ, aⱼ, uⱼ) [symbol] [symbol] ^{d} represents the d-dimensional feature space for publisher-ad-user tuple j and cⱼ [symbol] {−1, +1} is the corresponding class label (+1: click or −1: no-click). Given a publisher p, ad a and user u, the problem is to calculate the probability of click p(c|p, a, u). A maximum entropy algorithm may be used for this supervised learning task because of its simplicity and strength in combining diverse features and large scale learning. The maximum-entropy model, also known as logistic regression, may have the following form:

$$p ( c \vert p , a , u ) = \frac{1}{1 + exp ( {\sum }_{i = 1}^{d} {w}_{i} {f}_{i} ( p , a , u ) )} \qquad ( 1 )$$

where fᵢ(p, a, u) is the i-th feature derived from the publisher-ad-user tuple (p, a, u) and wᵢ [symbol] w is the weight associated with it. Given the training set D, the model learns the weight vector w by minimizing the total losses in the data formulated as:

$$LOSS ( w ) = {\sum }_{i}^{n} L ( w ; {f}_{i} ( {p}_{i} , {a}_{i} , {u}_{i} ) , {c}_{i} ) + \frac{λ}{2} {‖ w ‖}^{2} \qquad ( 2 )$$

where L( ) is a logistic loss function used in this paper and λ controls the degree of L2 regularization to smooth the objective function. The features used by the model are further described below with respect to FIG. 4. The model(s) generated by the modeler 206 are further described below with respect to FIG. 5.

FIG. 3 is a diagram of exemplary ad 201 types. There may be multiple types of ads that provided to the click predictor 112 from the advertiser server 122. The available ads may include image 304, video 306, interactive 308, and/or other rich media 310 ads. On example of rich media ads 310 is the utilization of Adobe® Flash for displaying animations or other movement. A floating or hover ad may be displayed on top of the content of the destination web page. Rich media ads 310 may expand or contract as part of the visual display of the ad. For example, an ad may expand to partially and temporarily hover/float over another part of the destination web page. The live ad preview may illustrate where the ad may hover and for how long the hover lasts. Rich media ads may interact with or push the content. The rich media or multimedia features of any of the ad 201 types may be utilized for modeling predicted clicks. For simplicity, the rich media 310 ads will be referred to as Flash.

FIG. 4 is a diagram of exemplary multimedia features. Features, including multimedia features, may be used by the modeler 206 for predicting clicks. Designing informative features may be necessary for supervised learning algorithms. Many features may be derived from the publisher-ad-user tuple. On the user side, demographic information such as age and gender may be common features used for click prediction. On the publisher and advertiser side there may be hierarchies of entities. The entity identifiers are typically used as features in click models to capture the click behavior at different levels of abstraction. Publishers may use site id to label their sites and may use section id to tag different parts of their pages. The url and host of the page may also be informative features. An advertiser may set up multiple campaigns and creatives and the same creative can be used in multiple campaigns. Finally, publishers and advertisers may connect to ad exchanges via networks, which constitute the root of the hierarchies. The identifier features may be binary indicators that take the value 1 when present and 0 otherwise. Other ad features that may be useful include the size of the ad, the topical category and the format (e.g. pop-up, floating or static banner ads). Conjunctions may be used to capture the interaction between different feature groups, such as user and publisher, publisher and ad, and user and ad conjunctions. The number of features may grow exponentially after feature conjunction. Given a large set of identifiers, the final number of parameters in the model may be very large. Feature hashing may be used as a simple and effective dimension reduction technique to limit the feature space as well as maintaining the model performance by hashing the feature to a predefined number of bins.

As described below and illustrated in FIG. 4, the features that are used for the model may be multimedia features 203. One type of multimedia feature 203 are image features 404. Image features 404 may include features generated from images and image elements in flash ads. The image features 404 may be designed to capture the visual aspects of the images that may affect users' response to the ads.

A digital image with resolution XXY may be treated as a grid of pixels with X rows and Y columns. The intensity of each pixel at location (x, y) may be represented in various color spaces including but not limited to RGB, Grayscale, HSV, HSL and YUV. RGB stores individual values for red (R), green (G) and blue (B) for each pixel at (x, y). RGB may be converted to grayscale and consequently to binary, black or white, by setting a threshold value on grayscale value. HSV (hue, saturation, value) is another color space that takes human perception into account in the color encoding. In HSV, the brightness of a pure color may be equal to the brightness of white. HSL (hue, saturation, lightness/luminance) is similar to HSV, except that the lightness of a pure color may be equal to the lightness of a medium gray. The YUV model defines a color space in terms of one luma (Y) and two chrominance (UV) components. Different color spaces characterize an image from different perspectives, based on which we can extract various features to describe the content of the image. The features extracted from the image may be divided into three categories, global features, local features, and high level features. Global features may be utilized to describe the content of the entire image using a small number of values. Local features represent the characteristics of the local regions of the image. Both global and local features may be computed directly from the image. The high-level features may attempt to capture the human visual perception of the image and may involve more complex processing of the underling image data that typically requires applying a model trained on an additional image corpus.

Global features capture the visual effect of the entire image as a whole and are generally easy to calculate. Exemplary global features that are described below may include the following: brightness, saturation, colorfulness, naturalness, contrast, sharpness, texture, grayscale simplicity, RGB simplicity, color harmony, and hue histogram.

Brightness of an image may be derived directly from two color spaces, such as the YUV color space where “Y” stands for the luma component (the brightness) and the HSL color space where “L” measures the lightness of the image. The average, standard deviation, maximum and minimum of the luminance and lightness values of all the pixels in the image may be derived as brightness features.

Saturation measures the vividness of an image, whose value may be established directly from the HSV or HSL color space. Similar to brightness, the average, standard deviation, maximum and minimum of the saturation may be calculated for all the pixels in the image.

Colorfulness of an image may be a measure of its difference against gray color.

Naturalness may be the degree of correspondence between images and human perception of reality. The quantitative description of naturalness may be based on grouping the pixels with 20≦L≦80 and S>0.1 in HSL color space according to their hue (H coordinate) value into three sets: Skin, Grass and Sky.

Contrast measures relative variation of luminance across the image in HSL color space. One definition of contrast is the standard deviation of the luminance L(x, y) of all image pixels. An extended version may include a calculation of the standard deviation of the normalized luminance of all image pixels as the contrast.

Sharpness measures the clarity level of detail of an image. Sharpness may be determined as a function of its Laplacian, normalized by the local average luminance in the surroundings of each pixel.

Texture features correspond to human visual perception by capturing the spatial arrangement of color or intensities in an image. The texture features may include the coarseness, contrast and directionality of the image.

Grayscale simplicity features may be extracted to represent the properties of the gray level image. Three features are extracted from the gray level histogram of the image consisting of 255 bins. The first one calculates the contrast of the image by measuring the width of the gray level histogram which consists of 95% of the pixels in the image. The second feature counts the number of gray bins which contains the significant number of pixels. This feature measures the simplicity of the image in grayscale. The third feature calculates the standard deviation of the gray level values of all the pixels in the image. The proposed gray level features may be effective in predicting the CTR of ads.

RGB simplicity features can represent the simplicity of a color image. Similar to grayscale simplicity, the RGB space may be quantized into 512 bins by dividing each channel into equal intervals. The number of RGB bins whose number of pixels are above a certain threshold is calculated as the simplicity feature in RGB space. The RGB bin with the maximum number of pixels may be removed as the dominant color and calculate its ratio with regard to the total number of pixels in the image as another feature. Two similar features can also be calculated in the HSV color space.

The color harmony property of an image may be correlated with the appeal of an image to a random user. Two features are extracted from the image based on the color harmonic distribution templates created from the hue value of HSV color space. From the HSV color space of an image, the average deviation from each color harmony template may be calculated and the deviation from the best two fitted models are reported as two color harmony features.

Hue histogram features may be based on the hue value of all the pixels in image. Each Hue value in HSL or HSV color space represents a color by itself. Three features may be extracted based on hue histogram of an image consisting of 20 bins. The first feature counts the number of bins including number of pixels more than a threshold value, indicated as number of significant hues. The second feature calculates the contrast of the hue histogram as the maximum arc length distance between any two significant bins. The third feature calculates the standard deviation of the hue arc length of all the pixels in the image, which shows the distribution of the hue color in the images.

In addition to global features, local features may also be considered because users may pay more attention to certain regions in an image. To generate local features, the image may be divided into many segments using a connected component algorithm. The global features that were discussed above may be extended onto the local regions and applied as a local feature. Other exemplary local features that are described below may include the following: basic segment statistics, segment hue histogram, segment color harmony, and segment brightness.

Basic segment statistics features may be extracted from the basic statistics of the segments. The first feature may the number of segments g in the image, which may indicate how busy an image is. Another feature is the contrast of segment sizes, which is calculated as the difference between the size of the largest and the smallest component. The third feature calculates the ratio of the largest connected color component to the whole image in terms of number of pixels. This feature will have a larger value for a smooth image. The fourth feature may be defined as the rank of the hue bin, considering the bin size in descending order, associated with the largest connected component in the image. The last two features may be calculated in the same way as the third and fourth feature except that they are based on the second largest connected component.

Segment hue histogram may be generated for each segment in the image. Similar to the global hue histogram features, six local hue features may be extracted: 1) the number of significant hues in the image falling in the largest segment, 2) the number of significant hues in the largest segment, 3) the largest number of significant hues among all the segments, 4) the contrast of the number of significant hues among all segments, 5) the contrast of the hues in the largest segment, and 6) the standard deviation of all segment's hue contrasts.

Segment color harmony features may be similar to the global color harmony features except that they are computed on the largest segment. Two features are generated, the minimum deviation from the best fitted color harmony model and the average deviation of the best two fitted color harmony models.

Segment brightness features may be based on the lightness of each segments calculated in HSL color space. Three features may be calculated, 1) the average lightness of all the pixels in the largest segment, 2) the standard deviation of average lightness among all the segments, and 3) the contrast of average lightness among all the segments.

The global and local features described above relate to the content of the image at low level of visual perception. There may be a set of more advanced features that is able to capture high level perception or conception information of an image. Exemplary high level features may include interest points, saliency map, text, and human faces.

Interest points are the pixels in the image that constitute the edges, e.g. high-contrast regions, of objects in an image. A SIFT algorithm (Scale-invariant feature transform) may be used to identify the interesting points for object detection. The number of interesting points may be used as a feature, which may indicate the complexity of an image in terms of the number of objects it contains.

Saliency map is a binary map detected from the image using saliency detection algorithms such as to distinguish the objects from the background whose saliency value is less than a predefined threshold. The saliency map may be used to extract many features, such as: 1) the ratio of background to the whole image, 2) the number of connected components of background, 3) the ratio of the largest connected component of background to the whole image, 4) the number of connect components in the saliency map, 5) the ratio of the largest connected saliency area to the whole image, 6) the average weight of the largest connected components of saliency map, 7) the distortion of the connected saliency areas calculated as the overall distance among all the components centroids, and 8) overall distance of all component centroids from the center of image.

Text in an image may be extracted using standard OCR (Optical Character Recognition) algorithms. Simple features such as the number of characters and number of words may be used as two possible features. These features may be independent from the content of the text.

Human faces in an image can be extracted by face detection algorithms. There may be four human face features: 1) the number of profile faces, 2) the proportion of profile faces in terms of pixels, 3) the number of frontal faces, and 4) the proportion of frontal faces in terms of pixels.

As shown in FIG. 4, another type of multimedia feature 203 includes flash features 406, such as the meta information extracted from flash ads. Features extracted from flash ads may provide additional information for the click prediction model. A flash ad may decomposed into many elements including image, sound, font, text, button, shape, frame, and action. The image features described above may be applied to the extracted image element of the flash ad. Additional exemplary flash features include counting the number of movie clips, shapes, fonts and frames in the flash. Additional exemplary flash features include an audio feature which indicates whether a flash ad contains audio. A flash ad with audio may be more attractive to users than soundless ads. Additional exemplary flash features include text features, such as a number of characters, number of words, or a number of pre-determined keywords (e.g., “click”, “free”) which may be derived from the text elements in the flash.

As shown in FIG. 4, another type of multimedia feature 203 includes mixture component features 408. The mixture component features 408 may include the latent mixture components from the images to capture their shared visual content as a separate set of features for click prediction. When users look at a display ad they may not perceive it as a matrix of pixels, but rather they process the content of the ad. Images with similar content may receive similar responses from users. One way to capture this is to cluster images based on content similarity and use the cluster membership as a feature. For example, a Gaussian Mixture Component (GMM) model or a Probabilistic Latent Semantic Analysis (PLSA) may be used. The weight of mixtures, as well as the mean vectors and covariance matrices for each mixture, may be learned through a maximum likelihood process from the images in the training set. For every image in the test data there may be an estimate of the probability of component membership from the learned model. The component id with the maximum posterior probability may be used as the mixture component feature in the click model.

As shown in FIG. 4, another type of multimedia feature 203 includes user/publisher conjunction features 410. The image and flash features extracted from the ads may be conjoined with user and publisher side features. For instance, the user age and ad color may be used as an additional feature to capture the variations in different age groups' responses to different colors. The “attractiveness” of a rich media ad to different users will vary since users may have different interests and taste. For example, male and female users may react differently when seeing an ad with a beautiful human face. Further, young users may be more attracted to ads with cartoons than older users. The ad performance on different publishers also varies. As another example, ads with cars in the image may be more likely to be clicked when shown on a automobile related site than when shown on a fashion site. These factors may not be taken into account by the multimedia features introduced above since they are extracted from the ad content. Conjunction features solve this problem by taking the cross product of the user features (such as age, gender etc.) or publisher features (such as publisher id, URL, etc.) with the multimedia features.

The generated models may include different variations of multimedia features in addition to non-multimedia features. In one embodiment, multimedia features are added to a baseline model of non-multimedia features. For example, the baseline model may include publisher, user, and advertisement features. Publisher features may include a publisher id, publisher network id, section id, URL and/or host. User features may include demographics, such as age and gender. Advertisement features may include advertiser id, campaign id, creative id, advertiser network id, ad size, offer type id, and/or pop type id. In one embodiment, the model may include the mixture component feature to the baseline model. The number of components may be set to a certain number. The models may use a 24-bit hash function to hash all the features. As a result, adding multimedia features may not increase the total number of features.

In another embodiment, the features may be selected based on the feature selection. Features may be ranked based on an estimated relevance to the prediction target in the training data, which may be measured using a standard mutual information method. Irrelevant features may be removed by thresholding the relevance score. Using a spectral clustering method, similar features may be grouped together. A fully connected similarity graph may be constructed, in which nodes represent features and edge weights are defined by the similarity (in terms of mutual information) of the two features they connect. A normalized cut method may be applied to the graph to obtain clusters of features that are strongly correlated with each other. Finally features within each cluster may be ranked using the relevance score and only the top k features in each cluster are selected to build the model. There may be a trade-off between relevance and redundancy that can be tuned by varying the k according to the size of the cluster.

The model generated by the modeler may utilize different multimedia features with different weights to focus on certain features which may be more relevant to the click through rate. For example, the following observations may be examples that are identified through the model. CTR may increase almost linearly with the minimum brightness of the ads. Large background image ads receive less clicks than small background image ads. Flash ads with audio may generate more clicks than flash ads without audio. Ads with larger number of interest points have lower CTR than ads with a small number of interest points. When an image ad has more pixels of dominant color (simpler), it is likely to generate more clicks. There may be a negative correlation between the CTR and the number of characters detected in the image. Image ads with a small number of connected components obtained from segmentation may be generally preferred by users over image ads with a large number of connected components. Image ads whose largest connected component is big may be more likely to receive more clicks. There may be a negative correlation between the CTR and the number of faces detected in the image. Many of these exemplary observations are consistent with each other. For example, “simple” images often have a small number of interest points, a few connected components, or a high ratio of dominant color. These observations may also be used to guide the creative design process for the purpose of increasing their CTR.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A system for click prediction comprising:
a publisher server for providing a page that includes at least one advertisement slot;
an advertisement server for providing an advertisement; and
a click predictor comprising:
an extractor that extracts multimedia features from the advertisement;
a comparator that compares at least one of the advertisement, the multimedia features, or the at least one advertisement slot with historical click history data; and
a modeler that utilizes a click prediction model that incorporates the multimedia features and the comparison with the historical click history data.

2. The system of claim 1 wherein the comparator compares the multimedia features of the advertisement with historical click history from advertisements with similar multimedia features.

3. The system of claim 1 wherein the modeler generates the click prediction model.

4. The system of claim 1 wherein the multimedia features comprise at least one of image features, flash features, mixture component features, or conjunction features.

5. The system of claim 4 wherein the image features comprise global features that apply to an entire image or local features that apply to segments of the entire image.

6. The system of claim 5 wherein the image features comprise at least one of brightness, saturation, colorfulness, naturalness, contrast, sharpness, texture, grayscale simplicity, color simplicity, color harmony, or hue, further wherein any of these image features comprise either a global feature or a local feature.

7. The system of claim 4 wherein the mixture feature comprises a clustering of images based on content similarity.

8. The system of claim 7 wherein a Gaussian Mixture Component model is used for comparing content similarity.

9. A method for utilizing a click prediction model comprising:
identifying features for the click prediction model, wherein the features include multimedia features;
extracting the identified features, including the multimedia features, from an advertisement;
correlating the extracted features with historical click data for those features from other advertisements; and
utilizing the click predication model to estimate a success of the advertisement based on the correlation;
wherein the multimedia features comprise global features for the advertisement as a whole and comprise local features for segments of the advertisement.

10. The method of claim 9 wherein the success of the advertisement comprises a click through rate (“CTR”) or a conversion rate.

11. The method of claim 9 wherein the advertisement comprises a new advertisement without historical click data.

12. The method of claim 11 wherein the correlation comprises a comparison of the advertisement with other advertisements having similar multimedia features.

13. The method of claim 12 wherein historical click data for the other advertisements is used for the utilization of the click prediction model.

14. The method of claim 12 wherein a Gaussian Mixture Component model is used for comparing image similarity, wherein the feature comprises an image.

15. The method of claim 9 wherein the multimedia features comprise at least one of image features, flash features, mixture component features, or conjunction features.

16. The method of claim 9 wherein the advertisement comprises at least one image and wherein the multimedia features for that image comprise at least one of brightness, saturation, colorfulness, naturalness, contrast, sharpness, texture, grayscale simplicity, color simplicity, color harmony, or hue, further wherein any of these image features comprise either a global feature or a local feature.

17. The method of claim 16 wherein the global features are features for the entire image and the local features are for segments of the image.

18. A non-transitory computer readable medium having stored therein data representing instructions executable by a programmed processor for click prediction, the storage medium comprising instructions operative for:
identifying a plurality of multimedia features as part of a click prediction model;
receiving an advertisement for analysis by the click prediction model;
extracting at least a subset of the multimedia features from the advertisement;
comparing the extracted subset of multimedia features from the advertisement with the click prediction model that includes results data for similar multimedia features; and
modeling expected results data from the advertisement based on the comparison.

19. The computer readable medium of claim 18 wherein the results data comprises click data for those advertisements that have previously been displayed, wherein the click data is correlated with the multimedia features for those previously displayed advertisements.

20. The computer readable medium of claim 19 wherein the results data comprises a click through rate (“CTR”) or a conversion rate.
